(19) United States
(12) Patent Application Publication
(10) Pub. No.: US 2024/0181497 A1
(43) Pub. Date: Jun. 6, 2024

(54) PIEZOELECTRIC MICROMACHINED ULTRASONIC TRANSDUCER AND PIEZOELECTRIC MICROMACHINED ULTRASONIC TRANSDUCER ARRAY

(71) Applicant: SonicMEMS (ZhengZhou) Technology Co.,Ltd., Zhengzhou (CN)

(72) Inventors: Yi-Hsiang Chiu, Zhengzhou (CN); Rei Jinchi, Zhengzhou (CN)

(21) Appl. No.: 18/302,447

(22) Filed: Apr. 18, 2023

(30) Foreign Application Priority Data
Dec. 6, 2022 (TW) 111146828

(51) Int. Cl. B06B 1/06

(52) U.S. Cl. CPC B06B 1/0611; B06B 1/0629

(57) ABSTRACT

A piezoelectric micromachined ultrasonic transducer includes a silicon substrate, a first protective layer, a supporting pillar, a piezoelectric composite film and a second protective layer. The supporting pillar is in the cavity of the first protective layer, the non-supporting pillar regions in the cavity communicates with each other. The shortest distance between a wall of the first protective layer and the supporting pillar is a first distance. The piezoelectric composite film is provided with at least two communicating holes, and the communicating holes penetrate the piezoelectric composite film and are communicated with the cavity. The second protective layer fills the two communicating holes to close the cavity. The distance between the two communicating holes is greater than twice of the first distance, and a ratio of a height of the supporting pillar to the first distance is 1/70 to 1/200, and a width of the supporting pillar is 3-10 um.

### CROSS-REFERENCE TO RELATED APPLICATION

This non-provisional application claims priority under 35 U.S.C. § 119(a) to Patent Application No. 111146828 filed in Taiwan, R.O.C. on Dec. 6, 2022, the entire contents of which are hereby incorporated by reference.

### BACKGROUND

### Technical Field

The present invention relates to the field of sensing, and particularly relates to a piezoelectric micromachined ultrasonic transducer and a piezoelectric micromachined ultrasonic transducer array.

### Related Art

A piezoelectric micromachined ultrasonic transducer is a common sensing element, incident signals generated by the piezoelectric micromachined ultrasonic transducer can separate incident waves and reflected waves through a cavity formed inside, and a vacuum medium therein.

However, if the thickness and the size of the element are reduced, the vacuum influence ratio is more and more obvious. Piezoelectric elements, particularly the piezoelectric elements arranged in an array state, are easy to deform due to the vacuum attraction in the vacuumizing process. More importantly, serious deformation occurs, causing collapse or a phenomenon of mutual sticking among the piezoelectric elements or sticking to other elements. Thereby, abnormal operation of the whole piezoelectric micromachined ultrasonic transducer will be caused.

### SUMMARY

In order to solve above problems, in some embodiments, a piezoelectric micromachined ultrasonic transducer is provided. The piezoelectric micromachined ultrasonic transducer includes a silicon substrate, a first protective layer, a supporting pillar, a piezoelectric composite film and a second protective layer. The first protective layer is arranged on the silicon substrate and provided with a cavity. The supporting pillar is in the cavity, and the non-supporting pillar regions in the cavity communicate with each other. The shortest distance between a wall of the first protective layer and the supporting pillar is a first distance. The piezoelectric composite film is arranged on the first protective layer. A vertical projection of the piezoelectric composite film partially overlaps with the cavity, and a part of the bottom of the piezoelectric composite film is in contact with the supporting pillar. The piezoelectric composite film is provided with at least two communicating holes, and the two communicating holes penetrate the piezoelectric composite film and are communicated with the cavity. The second protective layer is on the surface of the piezoelectric composite film, and fills the two communicating holes to close the cavity. The distance between the two communicating holes is greater than twice of the first distance, and a ratio of a height of the supporting pillar to the first distance t is 1/70 to 1/200, and a width of the supporting pillar is 3-10 um.

In some embodiments, the piezoelectric micromachined ultrasonic transducer further includes a second supporting pillar, the second supporting pillar is in the cavity, and the non-supporting pillar regions and non-second supporting pillar regions in the cavity communicate with each other.

In some embodiments, the first distance is less than or equal to 150 um.

In some embodiments, the supporting pillar is made of amorphous silicon.

In some embodiments, the supporting pillar is made of tetraethoxysilane (TEOS).

In some embodiments, the piezoelectric composite film includes a first piezoelectric layer, a first electrode layer, a second piezoelectric layer and a second electrode layer which are sequentially stacked on the first protective layer. The piezoelectric composite film is further provided with a first opening and a second opening so as to respectively expose part of the first electrode layer and part of the second electrode layer.

More specifically, in some embodiments, the second protective layer is further provided with a first slot and a second slot, and the first slot and the second slot are respectively communicated with the first opening and the second opening so as to respectively expose part of the first electrode layer and part of the second electrode layer. A metal layer is filled in the first slot, the second slot, the first opening and the second opening.

Further, in some embodiments, an aluminum-copper alloy layer is arranged between the exposed parts of the first electrode layer and the second electrode layer and the metal layer.

More specifically, in some embodiments, the silicon substrate and the first protective layer are respectively provided with a first communicating slot and a second communicating slot, and the first communicating slot and the second communicating slot are respectively communicated with the first opening and the second opening so as to expose part of the first electrode layer and part of the second electrode layer. A metal layer is filled in the first communicating slot, the second communicating slot, the first opening and the second opening.

In some embodiments, the first piezoelectric layer and the second piezoelectric layer are made of aluminum nitride (AlN).

In some embodiments, the first electrode layer and the second electrode layer are made of molybdenum (Mo).

In some embodiments, the first protective layer and the second protective layer are made of tetraethoxysilane (TEOS).

In some embodiments, a piezoelectric micromachined ultrasonic transducer array is provided, which includes a silicon substrate and a plurality of piezoelectric micromachined ultrasonic transduction elements. The piezoelectric micromachined ultrasonic transduction elements are arranged on the silicon substrate and arranged in an array, and each piezoelectric micromachined ultrasonic transduction element includes a first protective layer, a piezoelectric composite film, and a second protective layer.

The first protective layer is arranged on the silicon substrate and is provided with the cavity, and the cavities of the piezoelectric micromachined ultrasonic transduction elements communicate with each other. The piezoelectric composite film is arranged on the first protective layer. A vertical projection of the piezoelectric composite film partially overlaps with the cavity, the piezoelectric composite film is provided with at least two communicating holes, and the two communicating holes penetrate the piezoelectric composite film and are communicated with the cavity. At least one of the piezoelectric micromachined ultrasonic transduction elements includes a supporting pillar, the supporting pillar is in the cavity, and a part of the bottom of each piezoelectric composite film is in contact with the supporting pillar. The non-supporting pillar regions in the cavity communicate with each other, the shortest distance between a wall of the first protective layer and the supporting pillar is a first distance, the distance between the two communicating holes is greater than twice of the first distance, and a ratio of a height of the supporting pillar to the first distance is 1/70 to 1/200, and a width of the supporting pillar is 3-10 um.

In some embodiments, the piezoelectric micromachined ultrasonic transducer array further includes a second supporting pillar, the second supporting pillar is in the cavity, and the non-supporting pillar regions and non-second supporting pillar regions in the cavity communicate with each other.

In some embodiments, the piezoelectric composite film includes the first piezoelectric layer, the first electrode layer, the second piezoelectric layer and the second electrode layer which are sequentially stacked on the corresponding first protective layer. The piezoelectric composite film is further provided with the first opening and the second opening to respectively expose part of the first electrode layer and part of the second electrode layer.

More specifically, in some embodiments, the second protective layer is provided with the first slot and the second slot, and the first slot and the second slot are respectively communicated with the first opening and the second opening so as to respectively expose part of the first electrode layer and part of the second electrode layer. A metal layer is filled in the first slot, the second slot, the first opening and the second opening.

More specifically, in some embodiments, the silicon substrate and the first protective layer are respectively provided with the first communicating slot and the second communicating slot. The first communicating slot and the second communicating slot are respectively communicated with the first opening and the second opening so as to expose part of the first electrode layer and part of the second electrode layer. A metal layer is filled in the first communicating slot, the second communicating slot, the first openings and the second opening.

In some embodiments, the first distance is less than or equal to 150 um.

In some embodiments, the supporting pillar is made of amorphous silicon, or made of tetraethoxysilane.

In the above embodiments, the supporting pillar is arranged in the cavities to provide part of rigidity, so that the piezoelectric composite films can be prevented from being deformed or collapsed due to vacuum attraction of the cavities during manufacturing, and the manufacturing yield is improved. The function of the piezoelectric micromachined ultrasonic transducer can be maintained.

### BRIEF DESCRIPTION OF THE DRAWINGS

FIG. 1 is a top view of a piezoelectric micromachined ultrasonic transducer array.

FIG. 2 is a cross-sectional diagram of an Embodiment I of a piezoelectric micromachined ultrasonic transducer.

FIG. 3 is a cross-sectional diagram of an Embodiment II of a piezoelectric micromachined ultrasonic transducer.

FIG. 4 is a cross-sectional diagram of an Embodiment III of a piezoelectric micromachined ultrasonic transducer.

FIG. 5 is a cross-sectional diagram of an Embodiment IV of a piezoelectric micromachined ultrasonic transducer.

FIG. 6 is a top view of a piezoelectric micromachined ultrasonic transducer array.

### DETAILED DESCRIPTION

It is to be understood that, if an element is described as “connected” or “arranged” to another element, it can be indicated that the element is directly on the other element, or that there might be an intermediate element, through which the element is connected to the other element. Conversely, if the element is described “directly located on the other element” or “directly connected to the other element”, it is understood that there is no intermediate element.

In addition, the terms “first”, “second”, and “third” are only used for distinguishing one element, component, region, layer, or part from another element, component, region, layer, or part, rather than indicating their inevitable sequence. In addition, relative terms such as “down” and “up” can be used herein to describe the relationship between one element and another. It should be understood that the relative terms are intended to include different orientations of apparatuses other than those shown in the drawings. For example, if an apparatus in one accompanying drawing is turned over, the element described as being on the “lower” side of other elements will be oriented on the “upper” side of other elements. This only means the relative azimuth relationship, not the absolute azimuth relationship.

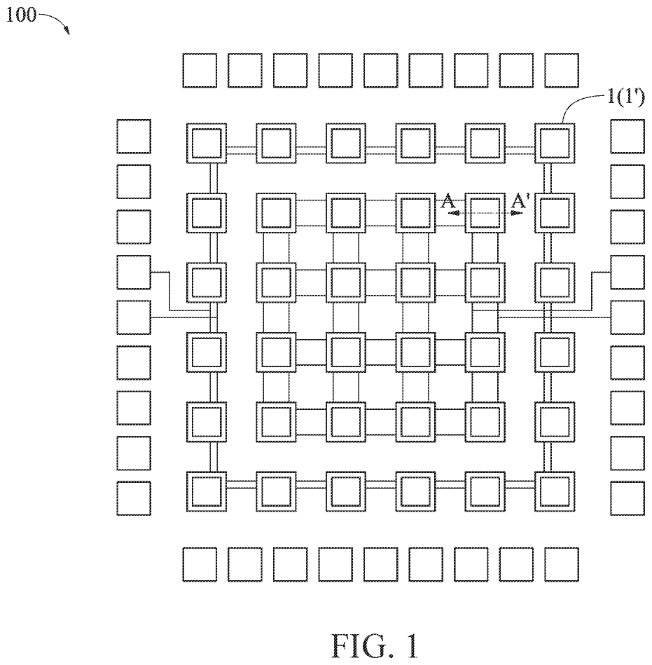

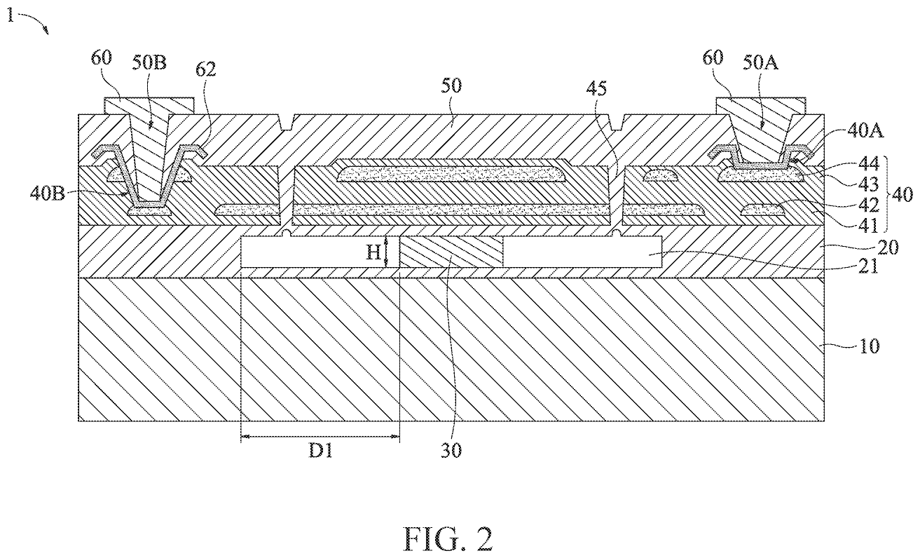

FIG. 1 is the top view of the piezoelectric micromachined ultrasonic transducer array. FIG. 2 is the cross-section of the Embodiment I of the piezoelectric micromachined ultrasonic transducer. FIG. 2 is the cross-sectional diagram of the Embodiment I of an A-A′ line in FIG. 1. As shown in FIG. 1 and FIG. 2, a piezoelectric micromachined ultrasonic transducer array 100 includes a plurality of piezoelectric micromachined ultrasonic transducers 1. The piezoelectric micromachined ultrasonic transducers 1 can be arranged in a two-dimensional array and are connected in series to achieve high piezoelectric conversion efficiency. The plurality of piezoelectric micromachined ultrasonic transducers 1 can be a plurality of piezoelectric micromachined ultrasonic transduction elements 1′ manufactured on the same silicon substrate 10, and can also be a plurality of piezoelectric micromachined ultrasonic transducers 1 which are separately manufactured and then are arranged.

As shown in FIG. 2, in some embodiments, the piezoelectric micromachined ultrasonic transducer 1 includes a silicon substrate 10, a first protective layer 20, a supporting pillar 30, a piezoelectric composite film 40 and a second protective layer 50. The first protective layer 20 is arranged on the silicon substrate 10 and provided with a cavity 21. The supporting pillar 30 is in the cavity 21, the piezoelectric composite film 40 is arranged on the first protective layer 20, the vertical projection of the piezoelectric composite film 40 partially overlaps with the cavity 21, and a part of the bottom of the piezoelectric composite film 40 is in contact with the supporting pillar 30. In other words, a part of the bottom of the piezoelectric composite film 40 is in indirect contact with the supporting pillar 30 through the first protective layer 20, and a part of the bottom of the piezoelectric composite film 40 overlaps with the vertical projection of the supporting pillar 30. The piezoelectric composite film 40 is provided with at least two communicating holes 45, and the two communicating holes 45 penetrate the piezoelectric composite film 40 and are communicated with the cavity 21. It is to be noted that due to a fact that a three-dimensional state cannot be completely presented through a cross section, the non-supporting pillar 30 regions in the cavity 21 communicate with each other, that is, the cavity 21 presents a state of surrounding the supporting pillar 30.

More specifically, in the manufacturing process, the first protective layer 20 can be made of tetraethoxysilane (TEOS), amorphous silicon is originally arranged in the first protective layer, the communicating holes 45 serve as inlet holes of etching gas, and the amorphous silicon is removed through controllable etching by controlling the charging concentration and the charging time of the etching gas. The residual amorphous silicon after etching serves as the supporting pillar 30.

The shortest distance between the wall of the first protective layer 20 and the supporting pillar 30 is the first distance D1. The distance between the two communicating holes 45 is greater than twice of the first distance D1, the ratio (H1/D1) of the height H1 of the supporting pillar 30 to the first distance D1 is 1/70 to 1/200, and the width of the supporting pillar 30 is 3-10 um. The second protective layer 50 is on the surface of the piezoelectric composite film 40 and fills the two communicating holes 45 to close the cavity 21. More specifically, the first distance D1 is less than or equal to 150 um. Preferably, the first distance is 70 um to 120 um. The range of the first distance D1 and the width of the supporting pillar 30 minimize the influence of a medium in the cavity 21, and maintain the overall structure.

The supporting pillar 30 is arranged in the cavity 21, so that the piezoelectric composite film 40 can be prevented from deformation and even collapse to cause sticking of the piezoelectric composite film 40 with the first protective layer 20 during vacuumizing the cavity 21 in the manufacturing process, the function damage of the piezoelectric micromachined ultrasonic transducer 1 is avoided, and the manufacturing yield is improved. Further, the effect of increasing the sound pressure of the piezoelectric micromachined ultrasonic transducer 1 can be achieved under a condition that the volume of the whole piezoelectric micromachined ultrasonic transducer 1 is reduced.

As also shown in FIG. 2, in some embodiments, the piezoelectric composite film 40 includes a first piezoelectric layer 41, a first electrode layer 42, a second piezoelectric layer 43 and a second electrode layer 44 which are sequentially stacked on the first protective layer 20. The piezoelectric composite film 40 is further provided with a first opening 40A and a second opening 40B to expose part of the first electrode layer 42 and part of the second electrode layer 44 respectively so as to facilitate electrical connection. More specifically, in some embodiments, the second protective layer 50 is further provided with a first slot 50A and a second slot 50B, the first slot 50A and the second slot 50B are communicated with the first opening 40A and the second opening 40B respectively to expose part of the first electrode layer 42 and part of the second electrode layer 44. A Metal layer 60 is filled in the first slot 50A, the second slot 50B, the first opening 40A and the second opening 40B to serve as welding pads electrically connected with a mother board. The first slot 50A and the first opening 40A as well as the second slot 50B and the second opening 40B can be completed together through drilling holes.

More specifically, in some embodiments, the first piezoelectric layer 41 and the second piezoelectric layer 43 are made of aluminum nitride (AlN), the first electrode layer 42 and the second electrode layer 44 are made of molybdenum (Mo), and an aluminum-copper alloy layer 62 is arranged between the exposed parts of the first electrode layer 42 and the second electrode layer 44 and the metal layer 60, so that the attaching properties of the metal layer 60 are improved.

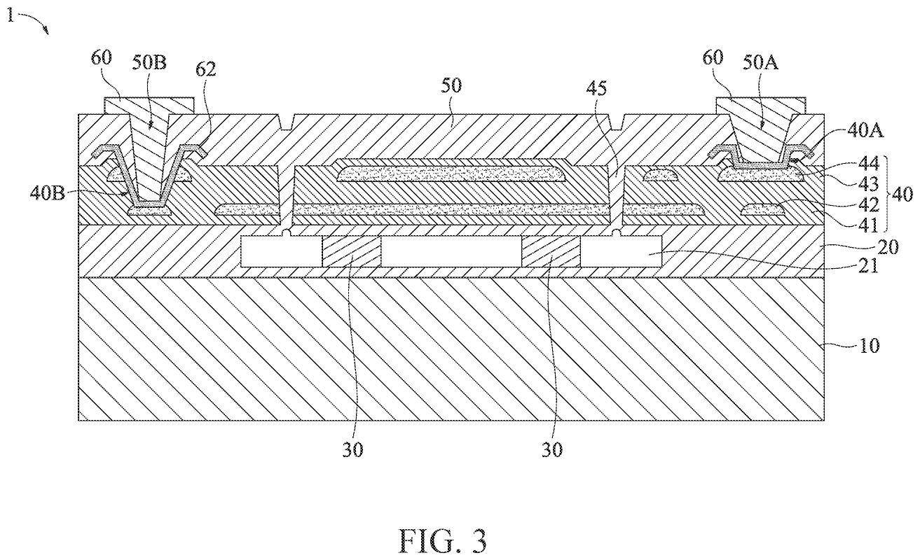

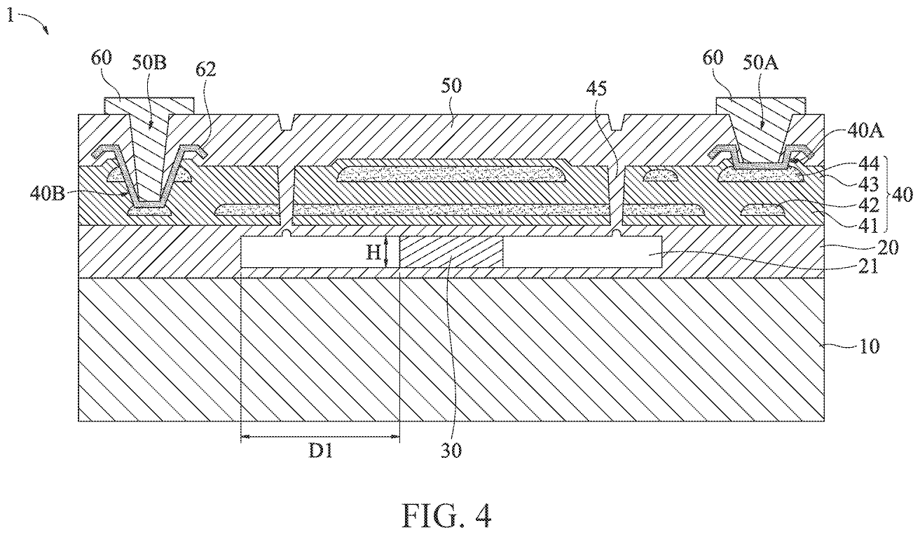

FIG. 3 is the cross-sectional diagram of the Embodiment II of the piezoelectric micromachined ultrasonic transducer. FIG. 4 is the cross-sectional diagram of the Embodiment III of the piezoelectric micromachined ultrasonic transducer. As shown in FIG. 3 and FIG. 4, and by referring to FIG. 2, the difference from FIG. 2 is that the supporting pillar 30 is also made of tetraethoxysilane (TEOS), and one (as shown in FIG. 4) or more (as shown in FIG. 3) supporting pillars 30 can be arranged in the cavity 21. Before polycrystalline silicon grows, tetraethoxysilane (TEOS) patterns are set, and the polycrystalline silicon grows in gaps among the patterns. When charging the etching gas, it is only needed to make sure that the polycrystalline silicon is completely removed, so that the manufacturing process is simplified. Similarly, the non-supporting pillar 30 regions in the cavity 21 communicate with each other.

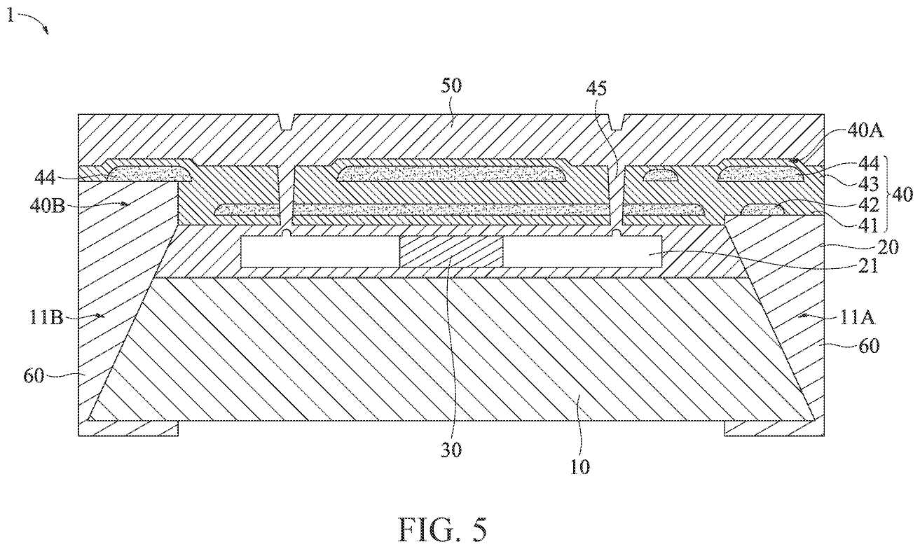

FIG. 5 is the cross-sectional diagram of the Embodiment IV of the piezoelectric micromachined ultrasonic transducer. As shown in FIG. 2 to FIG. 4, the difference of the Embodiment IV is that the piezoelectric composite film 40 is provided with positions for the first opening 40A and the second opening 40B at the bottom. The silicon substrate 10 and the first protective layer 20 are respectively provided with a first communicating slot 11A and a second communicating slot 11B. The first communicating slot 11A and the second communicating slot 11B are respectively communicated with the first opening 40A and the second opening 40B to expose part of the first electrode layer 42 and part of the second electrode layer 44. The first communicating slot 11A and the first opening 40A as well as the second communicating slot 11B and the second opening 40B can be formed by cutting off a part of the silicon substrate 10, the first protective layer 20 and the piezoelectric composite film 40 in an etching laser cutting or dry etching mode. The metal layer 60 is filled in the first communicating slot 11A, the second communicating slot 11B, the first opening 40A and the second opening 40B to serve as the welding pads.

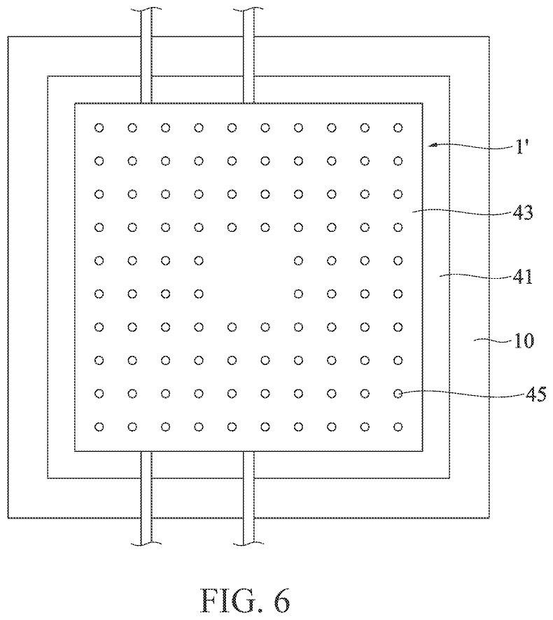

FIG. 6 is the top view of the piezoelectric micromachined ultrasonic transducer array. In order to clearly present, elements such as the second protective layer 50 and the metal layer 60 is omitted. Meanwhile, as shown in FIG. 1 to FIG. 5, the piezoelectric micromachined ultrasonic transducer array 100 can include a plurality of piezoelectric micromachined ultrasonic transduction elements 1′. Each piezoelectric micromachined ultrasonic transduction element 1′ can include the first protective layer 20 and the piezoelectric composite film 40. The first protective layer 20 is arranged on the silicon substrate 10 and is provided with the cavity 21, and the cavities 21 of the piezoelectric micromachined ultrasonic transduction elements 1′ communicate with each other.

At least one of piezoelectric micromachined ultrasonic transduction elements 1′ includes the supporting pillar 30, the supporting pillar 30 is in the cavity 21, and a part of the bottom of the piezoelectric composite film 40 is in contact with the supporting pillar 30. The cavities 21 of these piezoelectric micromachined ultrasonic transduction elements 1′ communicate with each other in the non-supporting pillar 30 regions, and the technical characteristics of the rest part are similar to those of a previous single piezoelectric micromachined ultrasonic transducer 1, and no more description is made herein. Further, in some embodiments, the piezoelectric micromachined ultrasonic transduction elements 1′ in the middle part cannot have the communicating holes 45, the cavities 21 of all the piezoelectric micromachined ultrasonic transduction elements 1′ directly communicate with each other in an etching mode, and the part which is not etched serves as the supporting pillar 30 of the whole cavity 21.

In conclusion, the supporting pillar 30 with width limitation is arranged in the cavity 21, so that the deformation and even collapse of the piezoelectric composite film 40 can be avoided during vacuumizing the cavity 21 in the manufacturing process, and the manufacturing yield is further improved. The effect of increasing the sound pressure of the piezoelectric micromachined ultrasonic transducer 1 can be achieved.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A piezoelectric micromachined ultrasonic transducer, comprising:
a silicon substrate;
a first protective layer arranged on the silicon substrate and provided with a cavity;
a supporting pillar in the cavity, wherein the shortest distance between a wall of the first protective layer and the supporting pillar is a first distance, and non-supporting pillar regions in the cavity communicate with each other;
a piezoelectric composite film arranged on the first protective layer, wherein a vertical projection of the piezoelectric composite film partially overlaps with the cavity, a part of the bottom of the piezoelectric composite film is in contact with the supporting pillar, the piezoelectric composite film is provided with least two communicating holes, and the two communicating holes penetrate the piezoelectric composite film and communicate with the cavity; and
a second protective layer on the surface of the piezoelectric composite film, and filling the two communicating holes to close the cavity,
wherein the distance between the two communicating holes being greater than twice of the first distance, and a ratio of a height of the supporting pillar to the first distance is 1/70 to 1/200, and a width of the supporting pillar is 3-10 um.

2. The piezoelectric micromachined ultrasonic transducer according to claim 1, further comprising a second supporting pillar, wherein the second supporting pillar is in the cavity, and the non-supporting pillar regions and non-second supporting pillar regions in the cavity communicate with each other.

3. The piezoelectric micromachined ultrasonic transducer according to claim 1, wherein the first distance is less than or equal to 150 um.

4. The piezoelectric micromachined ultrasonic transducer according to claim 1, wherein the supporting pillar is made of amorphous silicon.

5. The piezoelectric micromachined ultrasonic transducer according to claim 1, wherein the supporting pillar is made of tetraethoxysilane (TEOS).

6. The piezoelectric micromachined ultrasonic transducer according to claim 1, wherein the piezoelectric composite film comprises a first piezoelectric layer, a first electrode layer, a second piezoelectric layer and a second electrode layer which are sequentially stacked on the first protective layer; and the piezoelectric composite film is further provided with a first opening and a second opening to respectively expose part of the first electrode layer and part of the second electrode layer.

7. The piezoelectric micromachined ultrasonic transducer according to claim 6, wherein the second protective layer is further provided with a first slot and a second slot, and the first slot and the second slot are respectively communicated with the first opening and the second opening so as to respectively expose part of the first electrode layer and part of the second electrode layer; and a metal layer is filled in the first slot, the second slot, the first opening and the second opening.

8. The piezoelectric micromachined ultrasonic transducer according to claim 7, wherein an aluminum-copper alloy layer is arranged between the exposed parts of the first electrode layer and the second electrode layer and the metal layer.

9. The piezoelectric micromachined ultrasonic transducer according to claim 6, wherein the silicon substrate and the first protective layer are respectively provided with a first communicating slot and a second communicating slot, and the first communicating slot and the second communicating slot are respectively communicated with the first opening and the second opening so as to expose part of the first electrode layer and part of the second electrode layer; and a metal layer is filled in the first communicating slot, the second communicating slot, the first opening and the second opening.

10. The piezoelectric micromachined ultrasonic transducer according to claim 6, wherein the first piezoelectric layer and the second piezoelectric layer are made of aluminum nitride (AlN).

11. The piezoelectric micromachined ultrasonic transducer according to claim 6, wherein the first electrode layer and the second electrode layer are made of molybdenum (Mo).

12. The piezoelectric micromachined ultrasonic transducer according to claim 1, wherein the first protective layer and the second protective layer are made of tetraethoxysilane (TEOS).

13. A piezoelectric micromachined ultrasonic transducer array, comprising
a silicon substrate; and
a plurality of piezoelectric micromachined ultrasonic transduction elements arranged on the silicon substrate and arranged in an array, and each piezoelectric micromachined ultrasonic transduction element comprising:
a first protective layer arranged on the silicon substrate and provided with a cavity, and the cavities of the piezoelectric micromachined ultrasonic transduction elements communicating with one another;
a piezoelectric composite film arranged on the first protective layer, wherein a vertical projection of the piezoelectric composite film partially overlaps with the cavity, the piezoelectric composite film is provided with at least two communicating holes, and the two communicating holes penetrate the piezoelectric composite film and communicate with the cavity; and
a second protective layer on the surface of the piezoelectric composite film, and filling the two communicating holes to close the cavity,
wherein at least one of the piezoelectric micromachined ultrasonic transduction elements comprises a supporting pillar, the supporting pillar is in the cavity, and a part of the bottom of each piezoelectric composite film is in contact with the supporting pillar; the non-supporting pillar regions in the cavity communicate with each other; the shortest distance between the wall of the first protective layer and the supporting pillar is a first distance; the distance between the two communicating holes being greater than twice of the first distance; and a ratio of a height of the supporting pillar to the first distance being 1/70 to 1/200, and a width of the supporting pillar being 3-10 um.

14. The piezoelectric micromachined ultrasonic transducer array according to claim 13, further comprising a second supporting pillar, wherein the second supporting pillar is in the cavity; and the non-supporting pillar regions and non-second supporting pillar regions in the cavity communicate with each other.

15. The piezoelectric micromachined ultrasonic transducer array according to claim 13, wherein the piezoelectric composite film comprises a first piezoelectric layer, a first electrode layer, a second piezoelectric layer and a second electrode layer which are sequentially stacked on the first protective layer; and the piezoelectric composite film is further provided with a first opening and a second opening to respectively expose part of the first electrode layer and part of the second electrode layer.

16. The piezoelectric micromachined ultrasonic transducer array according to claim 15, wherein the second protective layer is provided with a first slot and a second slot, and the first slot and the second slot are respectively communicated with the first opening and the second opening so as to respectively expose part of the first electrode layer and part of the second electrode layer; and a metal layer is filled in the first slot, the second slot, the first opening and the second opening.

17. The piezoelectric micromachined ultrasonic transducer array according to claim 15, wherein the silicon substrate and the first protective layer are respectively provided with the first communicating slot and the second communicating slot, and the first communicating slot and the second communicating slot are respectively communicated with the first opening and the second opening so as to expose part of the first electrode layer and part of the second electrode layer; and a metal layer is filled in the first communicating slot, the second communicating slot, the first opening and the second opening.

18. The piezoelectric micromachined ultrasonic transducer array according to claim 13, wherein the first distance is less than or equal to 150 um.

19. The piezoelectric micromachined ultrasonic transducer array according to claim 13, wherein the supporting pillar is made of amorphous silicon, or made of tetraethoxysilane (TEOS).
